(19) United States
(12) Patent Application Publication
(10) Pub. No.: US 2026/0194677 A1
(43) Pub. Date: Jul. 9, 2026

(54) Enhancing Interface Waves Filtering by Hamiltonian Monte-Carlo Sampling

(71) Applicant: Saudi Arabian Oil Company, Dhahran (SA)

(72) Inventor: Mamadou Sanou Diallo, Dhahran (SA)

(73) Assignee: Saudi Arabian Oil Company, Dhahran (SA)

(21) Appl. No.: 19/010,866

(22) Filed: Jan. 6, 2025

(51) Int. Cl. G01V 1/36; G01V 1/34

(52) U.S. Cl. CPC G01V 1/364; G01V 1/345; G01V 2210/21; G01V 2210/22; G01V 2210/74

(57) ABSTRACT

Filtering interface waves from seismic data using Hamiltonian Monte Carlo (HMC) sampling to produce filtered seismic data. A time frequency transform up to a maximum frequency is performed on single component or multicomponent seismic data. An attribute for distinguishing interface waves is transformed to produce a normalized attribute. HMC sampling is applied to sample the time-frequency coefficients associated most likely associated with the interface waves and identify the interface waves component. The interface wave component may be subtracted from the raw seismic trace using an adaptive subtraction algorithm.

### BACKGROUND

### Field of the Disclosure

The present disclosure generally relates to geophysical exploration using seismic surveying. More specifically, embodiments of the disclosure relate to the filtering of interface waves from seismic data.

### Description of the Related Art

In geophysical exploration, such as the exploration for hydrocarbons, seismic surveys are performed to produce images of the various rock formations in the earth (“subsurface”) or underwater (“subsea”). The seismic surveys obtain seismic data indicating the response of the rock formations to the travel of elastic wave seismic energy. Various types of seismic waves may be generated as the seismic data, and such seismic waves include evanescent wave types known as interface waves. Such interface waves are produced by the interaction of seismic waves at the solid/fluid or solid/solid boundaries. In land seismic data acquisition, the energetic dispersive seismic arrivals observed in seismic records, resulting from the interaction P- and SV-waves at a free surface (that is, solid/air interface), generate interface waves commonly referred to as surface waves or Ground-Roll. For marine seismic acquisition (ocean bottom cable (OBC) or ocean bottom node (OBN)), the interface waves generated at the fluid/solid interface are commonly referred to as Scholte waves. In seismic data processing for oil exploration, the interface waves may be attenuated (such as by filtering) from recorded data in order to reveal the reflection arrivals that are then further processed for imaging of potential oil and gas reservoirs. Various techniques may be used to attenuate these interface waves in the seismic data. However, existing attenuation techniques have specific spatial sampling requirements and typically depend on the availability of multicomponent seismic data. Existing techniques that use single component seismic data are multichannel and are subject to a spatial aliasing constraint. Moreover, existing attenuation techniques may be unable to effectively handle interface waves in marine, land, and transitions zones.

### SUMMARY

Various techniques exist for the attenuation of interface waves. These techniques can be broadly divided in two categories. One category includes techniques that rely on multicomponent data (land or marine) and takes advantage of the polarization attributes to separate the body waves which are linearly polarized from the interface waves which are elliptically polarized. The other category consists of various techniques that operate on single component data and use the estimated dispersion curves dispersion to model and subtract the interface wave arrivals from the recorded seismic data. In heterogeneous media, interface waves are dispersive, which means that different frequency components travel at different velocity. This dispersion characteristic may help distinguish interface waves from body waves (P-waves and S-waves). Analyzing seismic traces in the time-frequency domain may make it easier to observe and characterize dispersive seismic events. Including polarization attributes such as ellipticity ratio and tilt-angle, in the analysis enables the filtering of interface waves from the recorded seismic traces. There is an extensive literature coverage of polarization techniques developed for the analysis and filtering of interface waves in earthquake seismology and exploration seismic.

For example, continuous wavelet transforms (CWT) is a type of time-frequency transform. For a given function x(t), the corresponding continuous wavelet transform with respect to a mother wavelet g(t) may be expressed as:

$${W}_{g} ( b , a ) = {\int }_{- ∝}^{+ ∝} {g}^{*} ( \frac{t - b}{a} ) x ( t ) dt , \qquad ( 1 )$$

where a and b are the dilation (related to frequency) and translation (related to time) parameters. The function x(t) may be real or complex and can be recovered by inverse wavelet transform. The wavelet coefficients can be expressed in terms of amplitude |W_{g}(b,a)| and phase φ(b,a) as follows:

$${W}_{g} ( b , a ) = \vert {W}_{g} ( b , a ) \vert {e}^{i ϕ ( b , a )} . \qquad ( 2 )$$

For multicomponent seismic data, interface waves may be filtered based on their distinctive polarization characteristics and amplitude in the time-frequency domain, such as described in Diallo et al., “Application of constrained polarization filtering for surface-wave mitigation: Three case studies,” Geophysics, 77, no. 5, V169-V181 (2013).

For actual seismic data, the polarization characteristics in the time-frequency domain do not provide a clear-cut distinction between surface-waves and reflection arrivals. To minimize damaging the signal, the wavelet-ridge has typically been used to delineate the contour of interface surface-wave contribution in the time-frequency domain, such as described in Delprat et al., “Asymptotic wavelet and Gabor analysis: Extraction of instantaneous frequencies”: IEEE Transactions on Information Theory, 38, 644-664 (1992).

The disadvantage of using the wavelet-ridge as a constraint is that it only captures the strongest component of the interface wave energy to be filtered and requires additional parametrization settings to sample the wavelet coefficients associated with the interface wave arrivals Moreover, once the contour is determined, a thresholding parameter is still used for each attribute to filter the interface wave. Unfortunately, the attributes' thresholding cannot handle the inherent variability of the interface waves characteristics. In some applications, the input data must be divided multiple subsets in in order to be able to define usable threshold attributes for the attenuation of interface wave.

In view of the foregoing discussion, embodiments of the disclosure relate to filtering interface waves using Hamiltonian Monte Carlo sampling. Advantageously, the embodiments may be used with both single component and multicomponent seismic data. Moreover, the domain of analysis of the seismic trace may be any invertible time-frequency transform such as Gabor transform, continuous wavelet transform, S-transform, etc. Embodiments of the disclosure provide an efficient of sampling of the wavelet coefficients associated with the interface waves and that removes the requirement of repetitive setting of attributes' thresholds for each data subset. The sampling may be performed on any attributes than can potentially distinguish the interface waves from other the seismic arrivals.

In one embodiment, a computer-implemented method for producing filtered seismic data from seismic data having a seismic trace generated from a seismic receiver station configured to sense seismic signals originating from a seismic source station is provided. The method includes obtaining seismic data from the seismic receiver station and performing a time-frequency transform of the seismic data up to a maximum frequency (f_max) to produce transformed seismic data, such that the maximum frequency (f_max) defines a maximum of a frequency range of interface wave arrivals in the seismic data. The method also includes performing a transformation of an attribute of the transformed seismic data to produce a normalized attribute, performing, on the normalized attribute, a Hamiltonian Monte Carlo sampling of a parameter associated with interface waves to determine an interface wave component of the transformed seismic data, and adaptively subtracting the interface wave component from the seismic trace to produce the filtered seismic data.

In some embodiments, the method includes generating a seismic image from the filtered seismic data. In some embodiments, the seismic image depicts a geological structure. In some embodiments, the attribute is ellipticity ratio, tilt angle, amplitude, velocity, or phase. In some embodiments, performing, on the normalized attribute, a Hamiltonian Monte Carlo sampling of a parameter associated with interface waves to determine an interface wave component of the transformed seismic data includes determining a time-frequency pair identifying a location of a transform coefficient associated with interface waves and performing an inverse transform over a range to determine the interface component, such that the range is defined by the parameter, wherein the range is defined by the HMC parameter. In some embodiments, the seismic data is single component seismic data. In some embodiments, the maximum frequency (f_max) represents the maximum frequency of the interface wave arrivals in the seismic data.

In another embodiment, a non-transitory computer-readable storage medium having executable code stored thereon for producing filtered seismic data from seismic data having a seismic trace generated from a seismic receiver station configured to sense seismic signals originating from a seismic source station. The executable code has a set of instructions that causes a processor to perform operations that include obtaining seismic data from the seismic receiver station and performing a time-frequency transform of the seismic data up to a maximum frequency (f_max) to produce transformed seismic data, such that the maximum frequency (f_max) defines a maximum of a frequency range of interface wave arrivals in the seismic data. The operations also include performing a transformation of an attribute of the transformed seismic data to produce a normalized attribute, performing, on the normalized attribute, a Hamiltonian Monte Carlo sampling of a parameter associated with interface waves to determine an interface wave component of the transformed seismic data, and adaptively subtracting the interface wave component from the seismic trace to produce the filtered seismic data.

In some embodiments, the operations include generating a seismic image from the filtered seismic data. In some embodiments, the seismic image depicts a geological structure. In some embodiments, the attribute is ellipticity ratio, tilt angle, amplitude, velocity, or phase. In some embodiments, performing, on the normalized attribute, a Hamiltonian Monte Carlo sampling of a parameter associated with interface waves to determine an interface wave component of the transformed seismic data includes determining a time-frequency pair identifying a location of a transform coefficient associated with interface waves and performing an inverse transform over a range to determine the interface component, such that the range is defined by the parameter, wherein the range is defined by the HMC parameter. In some embodiments, the seismic data is single component seismic data. In some embodiments, the maximum frequency (f_max) represents the maximum frequency of the interface wave arrivals in the seismic data.

In another embodiment, a system is provided that includes a seismic source station, a seismic receiver station configured to sense seismic signals originating from a seismic source station, a seismic data processor, and a non-transitory computer-readable storage memory accessible by the seismic data processor and having executable code stored thereon for producing filtered seismic data from seismic data having a seismic trace generated from the seismic receiver station. The executable code has a set of instructions that causes the seismic data processor to perform operations that include obtaining seismic data from the seismic receiver station and performing a time-frequency transform of the seismic data up to a maximum frequency (f_max) to produce transformed seismic data, such that the maximum frequency (f_max) defines a maximum of a frequency range of interface wave arrivals in the seismic data. The operations also include performing a transformation of an attribute of the transformed seismic data to produce a normalized attribute, performing, on the normalized attribute, a Hamiltonian Monte Carlo sampling of a parameter associated with interface waves to determine an interface wave component of the transformed seismic data, and adaptively subtracting the interface wave component from the seismic trace to produce the filtered seismic data.

In some embodiments, the operations include generating a seismic image from the filtered seismic data. In some embodiments, the seismic image depicts a geological structure. In some embodiments, the attribute is ellipticity ratio, tilt angle, amplitude, velocity, or phase. In some embodiments, performing, on the normalized attribute, a Hamiltonian Monte Carlo sampling of a parameter associated with interface waves to determine an interface wave component of the transformed seismic data includes determining a time-frequency pair identifying a location of a transform coefficient associated with interface waves and performing an inverse transform over a range to determine the interface component, such that the range is defined by the parameter, wherein the range is defined by the HMC parameter. In some embodiments, the seismic data is single component seismic data. In some embodiments, the maximum frequency (f_max) represents the maximum frequency of the interface wave arrivals in the seismic data.

### BRIEF DESCRIPTION OF THE DRAWINGS

FIG. 1 is a flowchart of a process for filtering interface waves using Hamiltonian Monte Carlo (HMC) sampling in accordance with an embodiment of the disclosure;

FIG. 2 depicts a representation of a seismic trace (on a plot of frequency vs. time) with example reflection wave arrivals and interface wave arrivals in accordance with an embodiment of the disclosure;

FIG. 3 is a block diagram of a system for producing single component or multicomponent seismic data and filtering interface waves using HMC sampling in accordance with an embodiment of the disclosure; and

FIG. 4 is a block diagram of a seismic data processing computer 900 in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to systems, methods, and computer-readable media for filtering interface waves from seismic data using Hamiltonian Monte Carlo (HMC) sampling and producing a seismic image from the filtered seismic data. The interface waves' attributes are sampled in multidimensional space using HMC to identify the time-frequency space of interface waves. The identified interface wave component is subtracted from the seismic trace to produce the filtered seismic data.

The following paragraphs discuss the derivation of the HMC solution for use in seismic data processing and filtering interface waves. The HMC solution is an improved version of Markov Chain Monte Carlo (MCMC) and is achieved by replacing the random-walk driven proposal mechanism of exploring the state variables with the deterministic approach and physics-based intuition of HMC. As described in the disclosure, HMC may be used to efficiently sample and delineate the time-frequency space occupied by interface waves. Advantageously, the application of the HMC sampling approach removes the requirement to set thresholding values of the interface waves' attributes and instead redefines the contour of the interface waves using the probability density of the associated attributes.

The motion of particles in an n-dimensional space where q represent the generalized position and p the generalized momentum may be completely determined by Hamiltonian formalism. The partial derivatives of Hamiltonian H(q,p), describes how p and q vary over “time” τ according to Hamiltonian's equations:

$$\frac{d {q}_{i}}{d τ} = \frac{\partial H}{\partial {p}_{i}} , \qquad ( 3 )$$

$$\frac{d {p}_{i}}{d τ} = - \frac{\partial H}{\partial {q}_{i}} , \qquad ( 4 )$$

where i=1 . . . n. The parameter τ is a fictitious time used for tracking the evolution of each point particle in phase space, which is defined as the space described by the set of axes qᵢ and pᵢ. The generalized momentum may be defined as the following:

$${p}_{i} = {m}_{i} \frac{{dq}_{i}}{d τ} , \qquad ( 5 )$$

where the positive-valued mᵢ parameters constitute the masses of particles. At any position (qᵢ,pᵢ) in the phase space, the state vector Sᵢ is tangent to the trajectory of the particles and the vector ∇Hᵢ is perpendicular to that trajectory, with Sᵢ and ∇Hᵢ defined as follows:

$${S}_{i} = ( \frac{d {q}_{i}}{d τ} , \frac{d {p}_{i}}{d τ} ) \qquad ( 6 )$$

$$∇ {H}_{i} = ( \frac{\partial H}{\partial {q}_{i}} , \frac{\partial H}{\partial {p}_{i}} ) \qquad ( 7 )$$

Applying an adequate amount of momentum ensures that the particle will explore the phase-space within the confine of the limit of typical set. As discussed in Betancourt, “A Conceptual Introduction to Hamiltonian Monte Carlo,” arXiv: 1701.02434 (2018) (hereinafter “Betancourt”), this is analogous to the physical act of placing and keeping a satellite on a stable orbit around the earth by endowing it with the needed momentum to balance out the gravitational force that pulls it towards the surface of the earth. The Hamiltonian H(q,p) represents the total energy of the particle which is the sum of the kinetic energy K(p) and potential energy U(q):

$$H ( q , p ) = K ( p ) + U ( q ) . \qquad ( 8 )$$

Given the Hamiltonian, solving the set of 2n first order partial differential equations (as shown in Equation 3) fully determines the motion of the particles. In order to use Hamiltonian dynamics to sample the target distribution described in the disclosure, the distribution may be expressed as a potential energy function using the concept of canonical distribution from statistical mechanics. As the Hamiltonian is an energy function, the canonical distribution is defined as:

$$ρ ( q , p ) = α \cdot {exp}^{[ - H ( q , p ) ]} = α \cdot {exp}^{[ - K ( p ) ]} \cdot {exp}^{[ - U ( q ) ]} , \qquad ( 9 )$$

where the generalized position states q represents the set of parameters we want to sample, p represents the set of generalized momenta, and a is a normalizing constant in order for Equation (8) to represent a valid probability density. The kinetic may be expressed as follows:

$$K ( p ) = \frac{1}{2} {\sum }_{1}^{n} \frac{{p}_{i}^{2}}{{m}_{i}} \qquad ( 10 )$$

The potential energy may be defined as follows:

$$\begin{matrix}U ( q ) = - log ⌈ {ρ}_{posterior} ( q \vert data ) ⌉ \\ = - log ⌈ {ρ}_{prior} ( q ) \cdot {ρ}_{likelihood} ( data \vert q ) ⌉\end{matrix} \qquad ( 11 )$$

Where the two expressions between the two square brackets in Equation 11 are reminiscent of the definition of posterior distribution in Bayesian statistics for the first and the product of the prior distribution and the likelihood for the second.

Substituting Equations (10) and (11) into equation (9) and setting mᵢ=1 results in the following:

$$p ( q , p ) = α \cdot {ρ}_{prior} ( q ) \cdot {ρ}_{likelihood} \cdot ( data \vert q ) \cdot {exp}^{[ - \frac{1}{2} {\sum }_{1}^{n} {p}_{i}^{2} ]} . \qquad ( 12 )$$

Neal, R. M., “MCMC using Hamiltonian dynamics,” arXiv: 1206.1901 (2012), shows that the marginal distribution of the joint distribution ρ(q,p) with respect to the momenta p results in the posterior distribution ρₚₒₛₜ(q|data) may be expressed as follows:

$${ρ}_{posterior} ( q \vert data ) = α \cdot {ρ}_{prior} ( q ) \cdot {ρ}_{likelihood} \cdot ( data \vert q ) \qquad ( 13 )$$

which is independent of the momenta p because the integrals over exponential terms sum all to 1. As discussed in Betancourt, this marginalization is equivalent to projecting the trajectories of particles in the phase-space into trajectories of that explore our target distribution.

For purposes of the embodiments described in the disclosure, the marginalization resulting in Equation (12) may not be used to solve the Hamiltonian. Instead, the Hamiltonian dynamics expressed by differential equations (Equations 3 and 4) may be solved to explore the phase space (q,p) to obtain a sample of the target distribution parameters (the q's) and ignore the auxiliary parameters p. The procedure for this solution is as follows: First, starting from an initial state, a new value of p's may be chosen from a random gaussian distribution. Then, from the current state (q,p), the Hamiltonian trajectory may be followed for a finite amount steps (duration) ending at state (qᵣ,pᵣ). This proposed state may be accepted as the new state with the following probability:

$$min [ 1 , {exp}^{[ ( - H ( {q}_{τ} , {p}_{τ} ) + H ( q , p ) ]} ] \qquad ( 14 )$$

If this state is accepted, q_{τ} is recorded as a part of the target distribution parameters; if this state is not accepted, the trajectory remains at (q,p), a new p is selected from the random Gaussian distribution, and the movement of the particle is again followed by solving the Hamiltonian equations.

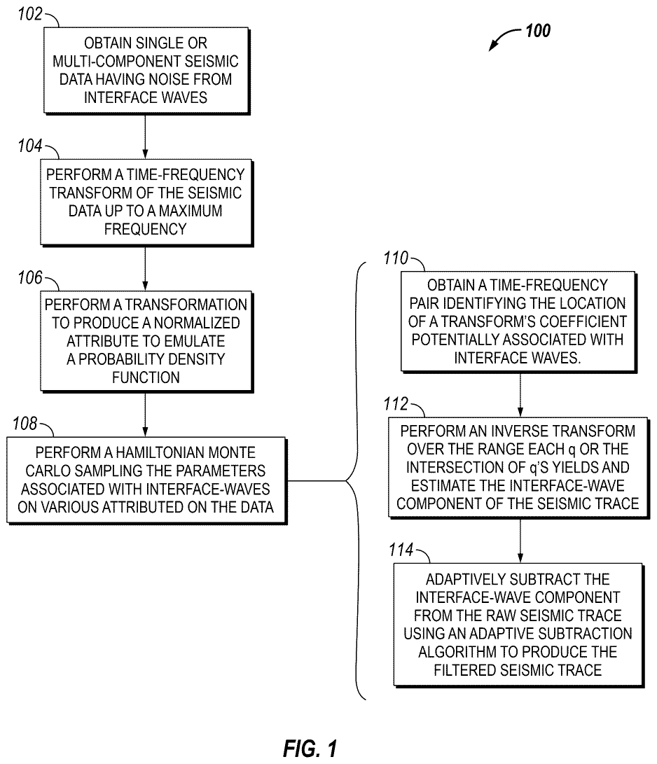

In view of the foregoing, FIG. 1 depicts a process 100 for filtering interface waves using Hamiltonian Monte Carlo sampling in accordance with an embodiment of the disclosure. Initially, single component or multicomponent seismic data (for example, raw receiver gathers or traces) may be obtained (block 102), such as by recording the single component or multicomponent seismic data at a seismic receiver (also referred to as a “receiver station”). As known in the art single component seismic data may include P-wave component data, while multi-component seismic data may include S-waves (shear waves) and P-waves. The single or multi-component seismic data may include noise from interface waves.

Next, a time frequency transform of the seismic data may be performed up to a maximum frequency (block 104). The maximum frequency (f_max) may be selected to cover the interface wave-arrival. The maximum frequency (f_max) may vary based on the type of environment and the type of seismic source. In some embodiments, the observed frequency band of interface waves in seismic data (land) does not generally extend beyond 30 Hz. The limited frequency in the time-frequency transform may improve computational efficiency.

Next, an attribute transformation is performed to produce a normalized attribute to emulate a probability density function (block 106). As used herein, the use the notation [symbol] (b,a) represents any attribute that can be used to characterize/distinguish interface waves from the body waves. In some embodiments, [symbol] (b,a) may represent for example, ellipticity ratio, tilt angle, amplitude, velocity, phase, or any other suitable attribute. Each of these attributes may be observed in the time-frequency space spanned by b and a. For each attribute to be used, a transformation on [symbol] (b,a) is performed to produce a normalized attribute [symbol] (b,a), such that ∫∫ [symbol] (b,a) dadb=1. This transformation emulates a probability density function where the highs of the function correspond to time-scale (frequency) (b, a) positions that are most likely associated with interface waves time-frequency components, and lows of the function correspond to other wave types that include reflection arrivals for preservation.

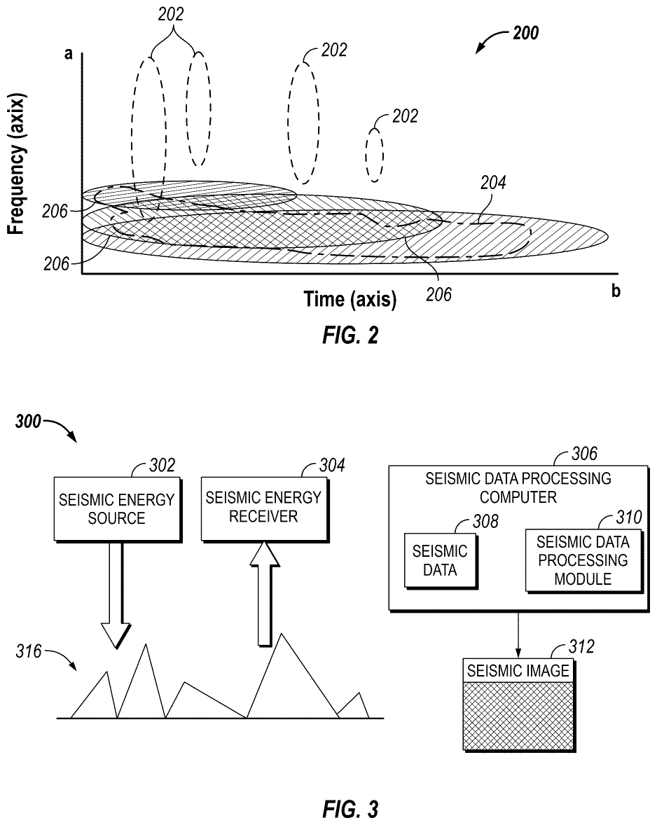

Next, a Hamiltonian Monte Carlo sampling of the parameters associated with interface waves on various attributes of the seismic data may be performed (block 108) to filter interface waves using Hamiltonian Monte Carlo sampling. As will be appreciated, in Hamiltonian notation, the generalized position space is two-dimensional (n=2) so that q=(q₁, q₂)=(b,a). For purposes of the description herein, p=(p₁, p₂) is selected to be of the same dimension as q. Using the HMC described supra, the parameter of the HMC phase-space (q,p) is used to sample the q parameters associated with interface waves on various attributes depending whether the seismic data is single component data or multicomponent data. For each component, a time-frequency pair identifying the location of a transform's coefficient potentially associated with interface waves is obtained (block 110). For example, FIG. 2 depicts a representation 200 of a seismic trace (frequency vs. time) with reflection wave arrivals 202 and interface wave arrivals 204 in the time-frequency domain in accordance with an embodiment of the disclosure. As shown in FIG. 2, the ellipses 206 with blue contours represent the distribution of q's determined using HMC sampling on an interface wave attributes. The time-frequency formed from the union of the ellipses 206 defines the domain of inversion of the time-frequency transform to obtain an estimate of the interface waves. This representation will have a negative axis for a complex seismic trace.

As shown in FIG. 1, an inverse transform may be performed over the range of each q or the intersection of q's yields to estimate the interface wave component of the seismic trace (block 112). Next, the estimate of the interface wave may be adaptively subtracted from the raw seismic trace using an adaptive subtraction algorithm to produce the filtered seismic trace (block 114).

The filtered seismic trace may be used to generate a seismic image of a region of interest (for example, a subsurface rock formation). In some embodiments, some initial samples (of the q's) that were accepted may be discarded, as these samples correspond to a “warm-up” (or “burn-in”) phase of the Markov Chain before it reaches the stationary transition distribution that preserves the target distribution.

Advantageously, embodiments of the disclosure provide an effective attenuation of interface waves (for example, Rayleigh, Schlote, and guided waves) for instances when these waves are greatly aliased and exhibit a strong amplitude. The embodiment may be applied to both single and multi-component data and eliminates the need for extensive testing and constrained to delineate the time-frequency space occupied by interface waves. Moreover, the techniques described herein provide improved control for filtering interface waves and avoidance of damage to the seismic data.

FIG. 3 depicts a system 300 for producing single component or multicomponent seismic data and filtering interface waves using HMC sampling in accordance with an embodiment of the disclosure. The system 300 can include, for example, a seismic source 302 (also referred to as a “seismic station”), a single component or multicomponent seismic receiver 304 (also referred to as a “receiver station”), a seismic data processing computer 306 that stores and processes seismic data 308, such as a shot gather responsive to seismic energy signals received by the seismic receiver, and seismic data processing module 310 that processes the seismic data 308 and produces a seismic image 312 from seismic data. In some embodiments, the seismic data processing module 310 may be implemented in Paradigm seismic processing software available from Emerson of Ferguson, Missouri, USA. For example, embodiments of the disclosure eliminate the requirement to specify constant values for attributes and do not need a velocity constraint when using interface wave filtering in such software.

According to various embodiments of the present disclosure, the seismic source 302 can include any seismic or acoustic energy whether from an explosive, implosive, swept-frequency, or random sources. The seismic source, for example, can generate a seismic energy signal that propagates into a geological structure 316. The geological structure may be representative of a structure in various geological environments, such as land or marine environment.

Generally, the seismic source 302 can emit seismic waves into the geological structure 316 to evaluate conditions and to detect possible concentrations of oil, gas, and other subsurface minerals. The propagation velocity of seismic waves may depend on the particular elastic medium through which the waves travel, particularly the density and elasticity of the medium as is known and understood by those skilled in the art. The refraction or reflection of seismic waves onto a seismic receiver 304 can be used to research and investigate subsurface structures of the earth 316.

Accordingly, the seismic receiver 304 can be positioned to receive and record seismic energy data or seismic field records in any form including, but not limited to, a geophysical time series recording of the acoustic reflection and refraction of waveforms that travel from the seismic source 302 to the seismic receiver 304. Variations in the travel times of reflection and refraction events in one or more field records in seismic data processing can produce seismic data 308 that demonstrates subsurface structures according to the techniques described herein. Seismic images produced from the seismic image data may be used to aid in the search for, and exploitation of, subsurface mineral deposits in the geological structure.

Generally speaking, seismic receivers 304 can record sound wave echoes (otherwise known as seismic energy signal reflections) that come back up through the ground from a seismic source 302 to a recording surface. Such seismic receivers 304 can record the intensity of such sound waves and the time it took for the sound wave to travel from the seismic source 302 back to the seismic receiver 304 at the recording surface. According to various embodiments of the present disclosure, for example, during the seismic imaging process, the reflections of sound waves emitted by a seismic source 302, and recorded by a seismic energy recording 304, can be processed by a computer to generate a seismic image, of the subsurface. The seismic image of the subsurface can be used to identify, for example, the placement of wells and potential well flow paths.

More specifically, the term seismic receiver 304 as is known and understood by those skilled in the art, can include geophones, hydrophones, ocean bottom cables (OBC), ocean bottom nodes (OBN), or other sensors designed to receive and record seismic energy. Accordingly, by placing a one or more geophone seismic receivers 304 at a recording surface, a two-dimensional seismic image can be produced responsive to seismic data recorded by the geophone seismic receivers 304. Some embodiments of the system 300 may include a plurality of single component seismic receivers. The single component seismic receiver may record a single component of a seismic wavefield (such as the P-wave component). Some embodiments of the system 300 may include one or more multicomponent component seismic receivers that record multiple components of a seismic wavefield (such as S-wave and P-wave components). Advantageously, embodiments of the disclosure enable the use of single component or multicomponent seismic data that may be produced by receivers 304.

According to an embodiment of the present disclosure, a seismic receiver 304 can be positioned to receive and record seismic energy data or seismic field records in any form including a geophysical time series recording of the acoustic reflection and refraction of waveforms that travel from the seismic source 302 to the seismic receiver 304. Variations in the travel times of reflection and refraction events in one or more field records in a plurality of seismic signals can, when processed by the seismic data processing computer 306, produce seismic data 308 that demonstrates various geological structures. As described herein, prior to using a seismic data 308 to aid in the search for, and exploitation of, mineral deposits, the seismic data 308 may be processed to enable the application of polarization filtering to the single component seismic data. The interpretation of the seismic image 312 generated from such data may be used to determine the location of wells drilling the geological structure 316. Thus, one or more drills may be drilled into the geological structure 316 in response to the generation and interpretation of the seismic image 312.

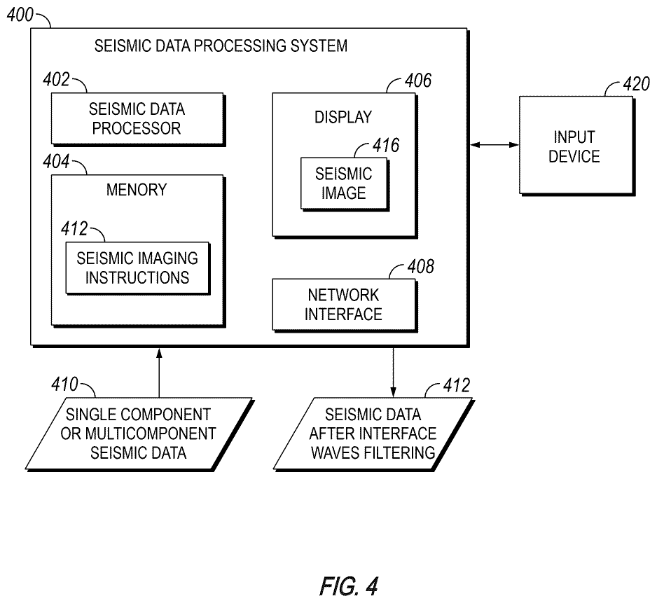

FIG. 4 depicts components of a seismic data processing computer 400 in accordance with an embodiment of the disclosure. In some embodiments, seismic data processing computer 400 may be in communication with other components of a system for obtaining and producing seismic data. Such other components may include, for example, seismic shot stations (sources) and seismic receiving stations (receivers). As shown in FIG. 9, the seismic data processing computer 400 may include a seismic data processor 402, a memory 404, a display 406, and a network interface 408. It should be appreciated that the seismic data processing computer 400 may include other components that are omitted for clarity. In some embodiments, seismic data processing computer 400 may include or be a part of a computer cluster, cloud-computing system, a data center, a server rack or other server enclosure, a server, a virtual server, a desktop computer, a laptop computer, a tablet computer, or the like.

The seismic data processor 402 (as used the disclosure, the term “processor” encompasses microprocessors) may include one or more processors having the capability to receive and process seismic data, such as data received from seismic receiving stations. In some embodiments, the seismic data processor 402 may include an application-specific integrated circuit (AISC). In some embodiments, the seismic data processor 402 may include a reduced instruction set (RISC) processor. Additionally, the seismic data processor 402 may include a single-core processors and multicore processors and may include graphics processors. Multiple processors may be employed to provide for parallel or sequential execution of one or more of the techniques described in the disclosure. The seismic data processor 402 may receive instructions and data from a memory (for example, memory 404).

The memory 404 (which may include one or more tangible non-transitory computer readable storage mediums) may include volatile memory, such as random access memory (RAM), and non-volatile memory, such as ROM, flash memory, a hard drive, any other suitable optical, magnetic, or solid-state storage medium, or a combination thereof. The memory 404 may be accessible by the seismic data processor 402. The memory 404 may store executable computer code. The executable computer code may include computer program instructions for implementing one or more techniques described in the disclosure. For example, the executable computer code may include seismic imaging instructions 412 that define a seismic image processing module to implement embodiments of the present disclosure. In some embodiments, the seismic imaging instructions 412 may implement one or more elements of process 100 described above and illustrated in FIG. 1. In some embodiments, the seismic imaging instructions 412 may receive, as input, single component or multicomponent seismic data 410 and may produce, as output a seismic data with filtered interface waves 414. In some embodiments, a seismic image 416 may be produced, stored in the memory 404 and, as shown in FIG. 9, displayed on the display 406.

The display 406 may include a cathode ray tube (CRT) display, liquid crystal display (LCD), an organic light emitting diode (OLED) display, or other suitable display. The display 406 may display a user interface (for example, a graphical user interface) that may display information received from the plant information processing computer 406. In accordance with some embodiments, the display 406 may be a touch screen and may include or be provided with touch sensitive elements through which a user may interact with the user interface. The display 406 may display the seismic image 416 produced using the seismic imaging instructions 412 in accordance with the techniques described herein. For example, the seismic image 416 may be produced from single component seismic data after the application of polarization filtering and attenuation of interface wave noise, as described in the disclosure.

The network interface 408 may provide for communication between the seismic data processing computer 400 and other devices. The network interface 408 may include a wired network interface card (NIC), a wireless (e.g., radio frequency) network interface card, or combination thereof. The network interface 408 may include circuitry for receiving and sending signals to and from communications networks, such as an antenna system, an RF transceiver, an amplifier, a tuner, an oscillator, a digital signal processor, and so forth. The network interface 408 may communicate with networks, such as the Internet, an intranet, a wide area network (WAN), a local area network (LAN), a metropolitan area network (MAN) or other networks. Communication over networks may use suitable standards, protocols, and technologies, such as Ethernet Bluetooth, Wireless Fidelity (Wi-Fi) (e.g., IEEE 802.11 standards), and other standards, protocols, and technologies. In some embodiments, for example, the unprocessed seismic data 4010 may be received over a network via the network interface 408. In some embodiments, for example, the seismic image 416 may be provided to other devices over the network via the network interface 408.

In some embodiments, seismic data processing computer may be coupled to an input device 420 (for example, one or more input devices). The input devices 420 may include, for example, a keyboard, a mouse, a microphone, or other input devices. In some embodiments, the input device 420 may enable interaction with a user interface displayed on the display 406. For example, in some embodiments, the input devices 420 may enable the entry of inputs that control the acquisition of seismic data, the processing of seismic data, and so on.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A computer-implemented method for producing filtered seismic data from seismic data having a seismic trace generated from a seismic receiver station configured to sense seismic signals originating from a seismic source station, the method comprising:
obtaining seismic data from the seismic receiver station;
performing a time-frequency transform of the seismic data up to a maximum frequency (f_max) to produce transformed seismic data, wherein the maximum frequency defines a maximum of a frequency range of interface wave arrivals in the seismic data;
performing a transformation of an attribute of the transformed seismic data to produce a normalized attribute;
performing, on the normalized attribute, a Hamiltonian Monte Carlo sampling of a parameter associated with interface waves to determine an interface wave component of the transformed seismic data; and
adaptively subtracting the interface wave component from the seismic trace to produce the filtered seismic data.

2. The method of claim 1, comprising generating a seismic image from the filtered seismic data.

3. The method of claim 2, wherein the seismic image depicts a geological structure.

4. The method of claim 1, wherein the attribute comprises ellipticity ratio, tilt angle, amplitude, velocity, or phase.

5. The method of claim 1, wherein performing, on the normalized attribute, a Hamiltonian Monte Carlo sampling of a parameter associated with interface waves to determine an interface wave component of the transformed seismic data comprises:
determining a time-frequency pair identifying a location of a transform coefficient associated with interface waves; and
performing an inverse transform over a range to determine the interface component, wherein the range is defined by the parameter, wherein the range is defined by the HMC parameter.

6. The method of claim 1, wherein the seismic data comprises single component seismic data.

7. The method of claim 1, wherein the maximum frequency (f_max) represents the maximum frequency of the interface wave arrivals in the seismic data.

8. A non-transitory computer-readable storage medium having executable code stored thereon for producing filtered seismic data from seismic data having a seismic trace generated from a seismic receiver station configured to sense seismic signals originating from a seismic source station, the executable code comprising a set of instructions that causes a processor to perform operations comprising:
obtaining seismic data from the seismic receiver station;
performing a time-frequency transform of the seismic data up to a maximum frequency (f_max) to produce transformed seismic data, wherein the maximum frequency defines a maximum of a frequency range of interface wave arrivals in the seismic data;
performing a transformation of an attribute of the transformed seismic data to produce a normalized attribute;
performing, on the normalized attribute, a Hamiltonian Monte Carlo sampling of a parameter associated with interface waves to determine an interface wave component of the transformed seismic data; and
adaptively subtracting the interface wave component from the seismic trace to produce the filtered seismic data.

9. The non-transitory computer-readable storage medium of claim 8, the operations comprising generating a seismic image from the filtered seismic data.

10. The non-transitory computer-readable storage medium of claim 9, wherein the seismic image depicts a geological structure.

11. The non-transitory computer-readable storage medium of claim 8, wherein the attribute comprises ellipticity ratio, tilt angle, amplitude, velocity, or phase.

12. The non-transitory computer-readable storage medium of claim 8, wherein performing, on the normalized attribute, a Hamiltonian Monte Carlo sampling of a parameter associated with interface waves to determine an interface wave component of the transformed seismic data comprises:
determining a time-frequency pair identifying a location of a transform coefficient associated with interface waves; and
performing an inverse transform over a range to determine the interface component, wherein the range is defined by the parameter, wherein the range is defined by the HMC parameter.

13. The non-transitory computer-readable storage medium of claim 8, wherein the seismic data comprises single component seismic data.

14. The non-transitory computer-readable storage medium of claim 8, wherein the maximum frequency (f_max) represents the maximum frequency of the interface wave arrivals in the seismic data.

15. A system, comprising:
a seismic source station;
a seismic receiver station configured to sense seismic signals originating from a seismic source station;
a seismic data processor;
a non-transitory computer-readable storage memory accessible by the seismic data processor and having executable code stored thereon for producing filtered seismic data from seismic data having a seismic trace generated from the seismic receiver station, the executable code comprising a set of instructions that causes the seismic data processor to perform operations comprising:
performing a time-frequency transform of the seismic data up to a maximum frequency (f_max) to produce transformed seismic data, wherein the maximum frequency defines a maximum of a frequency range of interface wave arrivals in the seismic data;
performing a transformation of an attribute of the transformed seismic data to produce a normalized attribute;
performing, on the normalized attribute, a Hamiltonian Monte Carlo sampling of a parameter associated with interface waves to determine an interface wave component of the transformed seismic data; and
adaptively subtracting the interface wave component from the seismic trace to produce the filtered seismic data.

16. The system of claim 15, the operations comprising generating a seismic image from the filtered seismic data.

17. The system of claim 16, wherein the seismic image depicts a geological structure.

18. The system of claim 15, wherein the attribute comprises ellipticity ratio, tilt angle, amplitude, velocity, or phase.

19. The system of claim 15, wherein performing, on the normalized attribute, a Hamiltonian Monte Carlo sampling of a parameter associated with interface waves to determine an interface wave component of the transformed seismic data comprises:
determining a time-frequency pair identifying a location of a transform coefficient associated with interface waves; and
performing an inverse transform over a range to determine the interface component, wherein the range is defined by the parameter, wherein the range is defined by the HMC parameter.

20. The system of claim 15, wherein the seismic data comprises single component seismic data.

21. The system of claim 15, wherein the maximum frequency (f_max) represents the maximum frequency of the interface wave arrivals in the seismic data.
